(19) United States
(12) Patent Application Publication
(10) Pub. No.: US 2008/0284211 A1
(43) Pub. Date: Nov. 20, 2008

(54) Wind Deflector for Motor Vehicles

(76) Inventors: Philipp Oerke, Munchen (DE); Rainer Mathias, Tutzing (DE)

Correspondence Address: DICKINSON WRIGHT PLLC, 1901 L. STREET NW, SUITE 800, WASHINGTON, DC, 20036, US

(21) Appl. No.: 12/091,613

(22) PCT Filed: Nov. 13, 2006
(86) PCT No.: PCT/DE2006/001977

§ 371 Date: Apr. 25, 2008

(30) Foreign Application Priority Data
Nov. 14, 2005 (DE) 102005054185.2

(51) Int. Cl. B60J 1/20

(52) U.S. Cl. 296/217

(57) ABSTRACT

The invention relates to a wind deflector (1) for motor vehicles, comprising a base element (2) that can be attached to part of the vehicle, an extension element (3), which is mounted so that it can pivot in relation to the base element, a displacement device (7) for pivoting the extension element (3) between a stored position and an extended position and at least one screening device (5, 6), which is provided at least in sections between the base element (2) and the extension element (3) and consists of a pliable material.

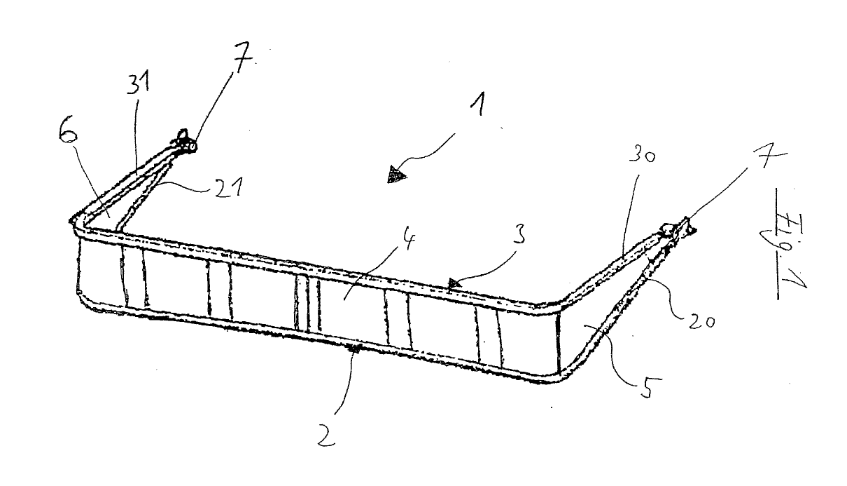

The present invention relates to a wind deflector for motor vehicles.

Although usable in any desired regions of a motor vehicle, the present invention and the problem on which it is based are explained in more detail with respect to a sliding roof of a motor vehicle. The present inventive concept can also be used, for example, on put-up roofs or sun roofs of a vehicle.

A problem which is generally known in the case of a motor vehicle sliding roof is that, when the cover is open, periodic pressure fluctuations may occur in the interior of the vehicle when the vehicle is moving at low to medium speeds. Said periodic pressure fluctuations are primarily noticeable acoustically in the form of “booming”. To avoid said pressure fluctuations, use is generally made of wind deflectors.

A wind deflector generally has the function of improving the flow conditions of the motor vehicle when, for example, the cover of a sliding roof is in an open position. The wind deflector is usually arranged at the front end, as seen in the direction of travel, of the roof opening opened up by the cover, and is transferred from a retracted position, in which it is located below the outer surface of the vehicle roof, into a deployed position when the cover is opened.

The publication DE 102 10 142 A1 discloses a wind deflector for a vehicle roof, the wind deflector having a base element which is provided for attachment to the vehicle roof. Furthermore, the wind deflector comprises a deployment element which is connected pivotably to the base element. Also provided are an air-permeable deflector element on the base element and on the deployment element, and at least one deployment spring which presses the deployment element into a deployed position in which the deflector element is tensioned between the base element and the deployment element. In this case, the deflector element is fixedly injected into the base element and into the deployment element.

However, a disadvantage of this approach according to the prior art is that the deflector element is fixedly connected integrally and fixedly to the base element and the deployment element via an injection. Since, in the deployed position, the deployment element adopts, in the two side regions, a profile in which it is inclined with respect to the base element, in the case of an injection of this type it is technically unfeasible or possible only with a very high outlay to tension the deflector element over the entire extent, and in particular in the lateral regions of the deployment element, between the deployment element and the base element, since the deflector element has to be adapted precisely to the changing distance between deployment element and base element. Certain manufacturing tolerances, play which occurs due to, for example, thermal expansion or the like, etc., cannot be compensated for by a fixed injection of this type, and therefore the deflector element is not completely tensioned, in particular in the side regions.

This firstly supplies a visually non-appealing overall impression, since the deflector element has a non-tensioned state at least in some parts and therefore sags. Secondly, a non-tensioned or sagging deflector element generates undesirable noises in the roof region due to the deflector element fluttering.

Furthermore, side screens in the interior of a sliding roof, the side screens having a concertina-like shape, are known to the applicant. The side screens are composed of plastic and form a bellows part with bellows folds running longitudinally. Said bellows are extended or compressed during the pivoting of the sliding roof cover.

However, a disadvantage of this approach is that concertina-like screens of this type require a large amount of construction space and have a relatively high weight.

The present invention is based on the object of eliminating the abovementioned disadvantages and, in particular, of providing a wind deflector which includes protection from prying eyes in a simple and cost-effective manner and at the same time ensures optimum flow conditions.

This object is achieved according to the invention by the wind deflector with the features of patent claim 1.

The idea on which the present invention is based involves the wind deflector having a base element which can be attached to a motor vehicle part; a deployment element which is mounted pivotably relative to the base element; an adjusting device for pivoting the deployment element between a storage position and a deployed position; and at least one screening device which is provided at least in sections between the base element and the deployment element and which is composed of an elastically stretchable material.

The present invention therefore has the advantage over the known approaches according to the prior art that protection from prying eyes is ensured in a simple and cost-effect manner, said protection at the same time constituting a protection against noise and avoiding underflows of air in a space- and weight-saving manner. Owing to its high degree of elasticity, the elastic screening device is adapted to the particular state of the deployment element and, in every position of the deployment element, ensures that the entire area of the associated region is covered. Complicated concertina-like bellows devices which take up a large amount of construction space can advantageously be avoided.

Advantageous refinements and improvements of the wind deflector indicated in patent claim 1 are found in the subclaims.

According to a preferred development, the at least one screening device is designed as a solid, elastic structure. This ensures continuous protection from prying eyes and favorable flow conditions.

According to a further preferred development, the at least one screening device has an elastic material or elastofibers, for example elasthans and/or elastodienes, or the like. Such materials or fibers are extremely stretchable and largely return to the original state when the tensile force is removed. Screening devices composed of fibers of this type therefore take up as small amount of construction space as possible in the storage position of the deployment element whereas they ensure that the entire area is covered in the deployed position of the deployment element.

According to a further preferred exemplary embodiment, the at least one screening device has a material with an elastic woven structure. Screening devices with an elastic woven structure are likewise highly stretchable and likewise essentially resume their original state when the tensile force is removed. Screening devices of this type also therefore take up a small amount of construction space in the storage position of the deployment element and, when the deployment element is in a deployed position, are correspondingly tensioned over the entire area so as to cover the entire area of the intermediate space between the base element and the deployment element.

According to a further preferred exemplary embodiment, the at least one screening device has at least one elastomer, for example a flexible plastic, a natural rubber or the like. Screening devices of this type have a rubber-elastic behavior and, upon a corresponding application of force, can be stretched to a multiple of their original length, with their initial length likewise approximately being resumed again after removal of the force required for the stretching. When the deployment element is in a deployed position, screening devices of this type, in the elastically stretched state, therefore likewise completely cover the associated surface and correspondingly contract so as to take up a small amount of construction space in the storage position of the deployment element.

A respective solid screening device is preferably provided in the regions of the lateral limbs of a U-shaped wind deflector. Both sides of the wind deflector therefore have favorable flow properties and each has suitable protection from prying eyes.

The screening devices can preferably each be attached to the base element and to the deployment element. An attachment of this type can be brought about, for example, by means of a releasable connection or by means of a fixed connection. For example, the entire wind deflector element is realized by means of an advantageously single-part screening device according to the invention.

The invention is explained in more detail below using exemplary embodiments and with reference to the attached FIGURE of the drawing.

The FIGURE illustrates a perspective view of a wind deflector 1 with integrated screening devices 5, 6 according to a preferred exemplary embodiment of the present invention.

As is apparent in the FIGURE, the wind deflector 1 comprises a base element 2 which can be fastened, for example, to an assembly frame of a roof opening. The roof opening can be closed by a cover of a sliding roof. The base element 2 is composed, for example, of plastic, has an approximately U-shaped configuration and is fitted along the front edge and at least partially along the lateral edges of the roof opening.

The wind deflector 1 furthermore has a likewise U-shaped deployment element 3 which is mounted such that it can be pivoted relative to the base element 2 between a storage position and a deployed position by means of a pivoting device 7. For example, the deployment element 3 is coupled pivotably to the base element 2.

In addition, a front deflector element 4 is provided in the front region between the base element 2 and the deployment element 3, said deflector element being composed of an air-permeable material, for example of an air-permeable fabric or an air-permeable sheet of plastic or the like. The front deflector element 4 is coupled to the base element 2 and the deployment element 3 in such a manner that, when a deployment element 3 is deployed, the front deflector element 4 is tensioned between the base element 2 and the deployment element 3, as illustrated in the FIGURE.

Furthermore, the wind deflector 1 has, for example, two lateral screening devices 5, 6, as illustrated in the FIGURE. For example, one lateral screening device 5 is arranged between the lateral limb 20, which is illustrated on the right in the FIGURE, of the base element 2 and the lateral limb 30, which is illustrated on the right in the FIGURE, of the deployment element 3, whereas the further lateral screening device 6 is provided lying opposite, symmetrically with respect thereto, between the lateral limb 21, which is illustrated on the left in the FIGURE, of the base element 2 and the lateral limb 31, which is illustrated on the left in the FIGURE, of the deployment element 3. The two screening devices 5, 6 are preferably respectively attached fixedly to the associated sections of the base element 2 and of the deployment element 3. However, a releasable connection of the screening devices 5, 6 to the associated sections of the base element 2 of the deployment element 3 is also conceivable.

The screening devices 5, 6 are preferably each designed as a solid structure and are composed of highly stretchable material. For example, the screening devices 5, 6 are composed of elastofibers which are extremely stretchable and largely return to the original state when a tensile force is removed. For example, elasthan which is composed of high-polymer fibers can be used as the elastofibers. As an alternative or in addition, use may also be made of elastodienes, i.e. fibers which are composed of synthetic polymers. Rubber fibers which are formed, for example, from natural rubber or the like, are likewise also conceivable. It is crucial for the material used to have a very high degree of elasticity.

As an alternative or in addition, the lateral screening devices 5, 6 can also be composed of elastomers which likewise have an excellent rubber-elastic behavior and can be stretched to a multiple of their length. These materials also immediately return again approximately to their initial length when a force required for the stretching is removed. In this case, either synthetic elastomers, such as, for example, flexible plastics, or natural elastomers can be used and can be combined with one another as desired.

It is obvious to a person skilled in the art that use can be made of any desired stretchable materials or screening devices, wherein the examples mentioned above are to be understood as merely being by way of example and can be combined with one another as desired.

As illustrated in the FIGURE, the lateral screening devices 5, 6 are preferably each arranged directly adjacent to the front deflector element 4, with it being possible for the front deflector element 4 to be designed, for example, likewise as a screening device with the abovementioned properties. It is also conceivable for the front deflector element 4 and the lateral screening devices 5, 6 to be formed together as a single-part screening device and therefore as a continuous, solid structure.

It is likewise possible for the lateral screening devices 5, 6 to be composed of a material which has an elastic woven structure. Materials of this type with an elastic woven structure are likewise extremely stretchable and are suitable for the purpose of the present invention.

In a storage position of the deployment element 3, in which the latter is pivoted from the deployed position illustrated in the FIGURE in the direction of the base element 2, the screening devices 5, 6 are in their initial state. When the deployment element 3 is pivoted from the storage position (not illustrated) into the deployed position (illustrated in the FIGURE), the screening devices 5, 6 are stretched elastically owing to their elastic property in such a manner that they are completely tensioned between the respectively associated limbs 20, 30 and 21, 31 of the base element 2 and of the deployment element 3, as is apparent in the FIGURE.

As a result, the present invention provides a wind deflector with lateral screening devices which take up a small amount of construction space and, when a deployment element is deployed, realize protection over the whole area from prying eyes, protection from noise and advantageously protection from wind in such a manner that underflows are avoided.

Although the present invention has been described above with reference to preferred exemplary embodiments, it is not restricted thereto but can be modified in diverse ways.

### LIST OF REFERENCE NUMBERS

1 Wind deflector
2 Base element
20 Lateral limb
21 Lateral limb
3 Deployment element
30 Lateral limb
31 Lateral limb
4 Front deflector element
5 Lateral screening device
6 Lateral screening device
7 Pivoting device

1. A wind deflector for motor vehicles, with:
a base element which can be attached to a motor vehicle part;
a deployment element which is mounted pivotably relative to the base element;
an adjusting device for pivoting the deployment element between a storage position and a deployed position; and with
at least one screening device which is provided at least in sections between the base element and the deployment element and which is composed of an elastically stretchable material.

2. The wind deflector as claimed in of claim 1, characterized in that the at least one screening device is designed as a solid, elastic structure.

3. The wind deflector of claim 1, characterized in that the at least one screening device is composed of an elastic material or of elastofibers, for example elasthan and/or elastodiene.

4. The wind deflector of claim 1, characterized in that the at least one screening device has a material with an elastic woven structure.

5. The wind deflector of claim 1, characterized in that the at least one screening device is composed of at least one elastomer, for example a flexible plastic, a natural rubber or the like.

6. The wind deflector of claim 1, characterized in that a respective solid screening device is provided in the regions of the lateral limbs of a U-shaped wind deflector.

7. The wind deflector of claim 6, characterized in that the at least one screening device can be attached to the base element and to the deployment element.
